(19) United States
(12) Patent Application Publication
(10) Pub. No.: US 2001/0034641 A1
(43) Pub. Date: Oct. 25, 2001

(54) Participant controlled mutual fund

(76) Inventors: Gregory A. D'Amico, Knoxville, TN (US); Robert A. Loest, Knoxville, TN (US)

Correspondence Address: JOHN S. PRATT, ESQ, KILPATRICK STOCKTON, LLP, 1100 PEACHTREE STREET, SUITE 2800, ATLANTA, GA, 30309, US

(21) Appl. No.: 09/780,964

(22) Filed: Feb. 9, 2001

Related U.S. Application Data
(60) Provisional application No. 60/181,580, filed on Feb. 10, 2000.
(60) Provisional application No. 60/221,255, filed on Jul. 27, 2000.

(51) Int. Cl. G06F 17/60

(52) U.S. Cl. 705/12; 705/36; 235/51

(57) ABSTRACT

A participant controlled mutual fund is directed by participants who make the investing decisions through an intricate nominating and voting process over the Internet. The voting process is flexible in that it adjusts to the changing positions in the financial markets, thereby allowing the mutual fund to quickly take advantage of good opportunities, while preventing haste decisions in volatile markets. An advisor executes the market orders generated by the participants and monitors the mutual fund to ensure that the fund complies with applicable law.

### RELATED APPLICATIONS

This application claims priority to, and incorporates by reference, co-pending provisional patent application Ser. No. 60/181,580 filed on Feb. 10, 2000, entitled “Mutual Fund” and co-pending provisional patent application Ser. No. 60/221,255 filed on Jul. 27, 2000, entitled “Interactive Mutual Fund.”

### FIELD OF THE INVENTION

This invention relates to the field of financial advisory services, and more particularly, to systems and methods for managing a mutual fund whose investment decisions are made by its shareholders.

### BACKGROUND OF THE INVENTION

Investing in one's future is a concept well grounded in modem society. Individuals invest in the security market for a variety of reasons. For instance, many invest in anticipation of retirement or in order to make a large purchase. Still others invest in the hope of striking it rich at any early age. Regardless of one's motivation for investing, each investor faces the quandary of what amount of risk is that particular investor willing to face.

One common method of reducing the risk of loss from investments is diversification. Diversification is a primary investment goal because it substantially reduces an investor's risks associated with reductions in the values of individual companies' securities and of the values of companies which do business primarily in a specific sector of the economy. Further, diversification increases the possibility that the investor will participate in the ownership of companies whose securities increase in value, thereby furthering the investor's goal of financial growth. Diversification within an investment portfolio can be accomplished through numerous avenues including; purchasing securities, public or private bonds, futures, options, commodities, real estate, real estate investment trusts, money market funds and certificates of deposit.

One of the most efficient means of diversifying an investment portfolio is to invest in a mutual fund. A mutual fund is formed with a collection of funds contributed by numerous individuals and corporate entities which have purchased shares of the fund. Historically, mutual funds have been a great tool for investors who have just recently started investing because it enables investors with relatively small amounts of money to diversify their portfolio, while maintaining transactional costs at a relatively modest level. Without the opportunity to invest in a mutual fund, investors would be forced to invest substantial amounts of money to properly diversify. Based in large part on the fact that most investors possess relatively modest investment portfolios, the mutual fund has become a very popular device for diversified investing.

Traditionally, mutual funds have been managed by money managers, who have been further supported by staffs. In this context, the money managers had the sole responsibility of effectively managing the fund by making the decisions to buy and sell the mutual fund's investments for the benefit of the participants. The money manager also had the responsibility for declaring dividends and ensuring that the fund operated in accordance with governing securities law.

While the traditional mutual fund allows an investor to instantly diversify the investor's investment portfolio, it has not solved all of the problems associated with investing, nor has the mutual fund eliminated the risk of loss from investing. Further, mutual funds are completely reliant upon the knowledge and expertise of the money managers and their staffs. While the managers are assumed to possess a plethora of knowledge, the managers are incapable of adequately researching all possible securities and keeping current on trends in all sectors of the economy. Thus, the fund's success is hampered by the limited knowledge of the manager.

Thus, a need exists for providing an investor with a means of diversifying an investor's investment portfolio, thereby reducing the risks associated with investing, while increasing the investor's ability to react quickly to market fluctuations in order to increase returns on the investments.

### SUMMARY OF THE INVENTION

Set forth below is a brief summary of the invention that addresses the foregoing problems and provides benefits and advantages in accordance with the purposes of the present invention as embodied and broadly described therein.

Generally speaking, the mutual fund of the instant invention shifts the responsibilities of managing a mutual fund from a money manager to the mutual fund's participants. In essence, the mutual fund relies on the collective intelligence of the participants rather than the exclusive intelligence of the manager. In operation, participants of the mutual fund decide which securities should be bought or sold from the mutual fund's holdings and the percentage of the portfolio to be bought or sold. According to another aspect of the invention, the participants determine the voting threshold, the market order percent (MOP), required before a financial investment is bought or sold.

In a preferred embodiment of the invention, the participants of a mutual fund make the investment decisions by voting on which securities the fund should buy and sell through the mutual fund's Web site. All parties who contribute money to the fund are eligible to vote on the securities that are purchased and sold by the mutual fund. The process of purchasing or selling a security begins when a participant nominates a security. Any participant or advisor may nominate a security. However, only those securities that conform with the objectives of the mutual fund, as set forth in the prospectus, and with applicable law are eligible for nomination.

Once a security has been nominated the security is placed on a nominee list. If the security is nominated for purchase, it is placed on the buy nominee list, and if the security is nominated for sale, it is placed on the sale nominee list. A participant of the mutual fund may vote one time during the voting cycle, which begins with the nomination of a security and ends with the purchase, sale or removal of the security from the nominee list. A nominated security becomes a candidate for purchase or sale once it has received votes from five percent of the outstanding shares of the mutual fund.

As a candidate, the security should receive votes from the participants totaling at least the percentage of shares corresponding to the MOP in order for the candidate to become subject to a market order. The MOP is a threshold of acceptance or agreement between participants that a security should receive before the advisor of the mutual fund may purchase or sell the security. The participants set the MOP each day by voting for the value that the investor believes the MOP should be for the next day. The voted on valued is averaged with the values from all other voting participants for all votes cast during the previous five days.

The MOP allows the participants to determine the amount of agreement that should exist prior to the advisor taking action on behalf of the mutual fund. During periods of extreme volatility in the financial markets, participants would most likely raise the MOP to prevent haste decisions. At other times, the MOP would probably be reduced to allow the advisor to act swiftly to take advantage of good opportunities. Thus, the MOP allows the mutual fund to adjust to the volatility in the market.

During the voting process for a candidate, the participant also includes the percentage of the portfolio that the participant would like for the mutual fund to purchase and the percentage of the total holding of that security which the participant would like for the mutual fund to sell. Once the number of votes received for the purchase or sale of a security obtains a level greater than the MOP, a market order is produced which directs the advisor to purchase or sell the security. The market order is administered by the advisor as soon as compliance is practicable.

### BRIEF DESCRIPTION OF DRAWINGS

The accompanying drawings, which are incorporated in and form a part of the specification, illustrate a preferred embodiment of the present invention and, together with the description, disclose the principles of the invention. In the drawings:

FIG. 1 is a block diagram of the preferred environment for operating the mutual fund.

FIG. 2A is a block diagram of the voting cycle used to determine whether a security should be bought or sold.

FIG. 2B is a block diagram of the operation of voting for the purchase or sale of security for the mutual fund.

FIG. 3 is a block diagram of the procedure undertaken to set the MOP for each day.

FIG. 4 is a screen display showing the introduction screen of the Web site.

FIG. 5 is a screen display showing the login screen used by an active participant.

FIG. 6 is a screen display showing the screen which contains information regarding how to purchase shares of the mutual fund.

FIG. 7 is a screen display showing the account information of the logged-in participant's account.

FIG. 8 is a screen display showing information originating from the mutual fund's advisor.

FIG. 9 is a screen display showing the screen where the participant may nominate a security for ultimate purchase by the mutual fund.

FIG. 10 is a screen display listing the nominated securities and enabling the participant to vote for the nominated security to become a candidate.

FIG. 11 is a screen display listing the candidate securities and allowing the participant to vote for ultimate purchase by the mutual fund.

FIG. 12 is a screen display of the logged-in participant's voting history.

FIG. 13 is a screen display of the history of the securities purchased and sold by the mutual fund.

FIG. 14 is a screen display showing relevant financial information of various companies.

FIG. 15 is a screen display of the rules governing the mutual fund's activities.

FIG. 16 is a screen display of the glossary of terms used by the mutual fund.

FIG. 17 is a screen display of answers to frequently asked questions organized by topic.

FIG. 18 is a screen display of a library of advisor commentaries organized by topic.

FIG. 19 is a screen display showing the screen where the participant may change the login password.

FIG. 20 is a screen display showing the address at which the participant can request a forgotten password.

FIG. 21 is a screen display showing the participant how to contact the advisor of the mutual fund.

FIG. 22 is a screen display showing the first screen of the tutorial.

FIG. 23 is a screen display showing the logout screen.

FIG. 24 is a block diagram of the preferred support systems for the fund system.

### DETAILED DESCRIPTION OF THE DRAWINGS

This invention relates to an participant-managed mutual fund. Unlike conventional mutual funds, a professional investment adviser does not select the mutual fund's holdings; instead, the participants determine the mutual fund's holdings. The participants of the mutual fund can control the purchase and sale of securities by the fund through the use of a computer network such as the Internet, with access to the World Wide Web (the Web).

I. Overview

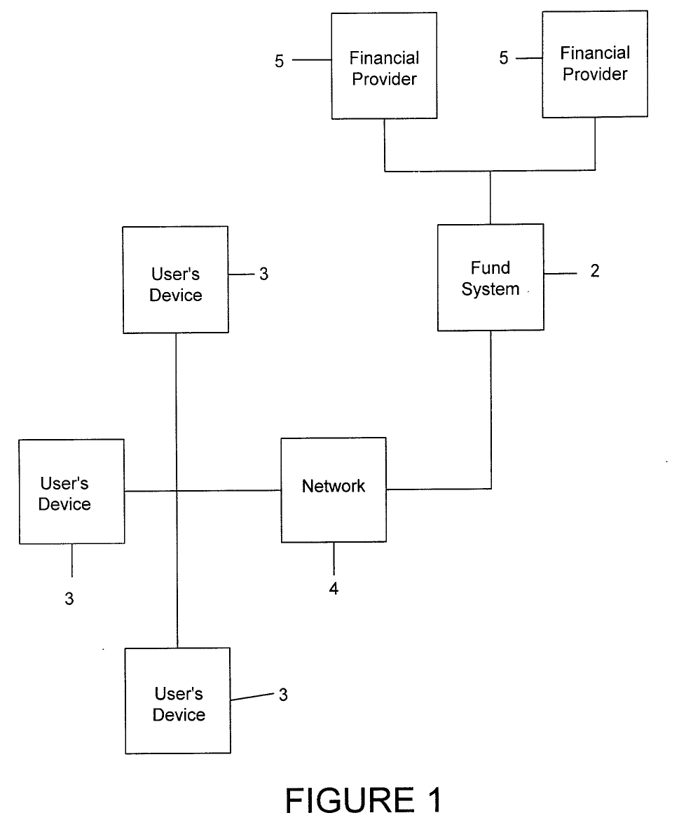

FIG. 1 provides a block diagram of the invention according to a preferred embodiment. In the preferred embodiment, participants of the participant-controlled mutual fund 1 are the co-owners of the mutual fund. The participants access the fund system 2 through the use of a user's device 3 in order to vote on which investment tool, security, the mutual fund should acquire and which of the mutual fund's holdings should be sold. In a preferred embodiment, the security is a stock. However, in an alternative embodiment, the security can include, but is not limited to, a public or private bond, futures, options, commodities, real estate, real estate investment trusts, money market funds, certificates of deposit, as long as a purchase of the security is not prohibited by law or contrary to the objectives of the mutual fund.

Furthermore, while the preferred embodiment is directed to a mutual fund, the management methods disclosed below are also applicable to all other investment devices which manage monies from more than one owner. The user's device preferably is a personal computer, but can include a telephone, a personal digital assistant (PDA), or other means of accessing the fund system 2. The user's device 3 connects to the fund system 2 through a network 4. The network 4 preferably is the World Wide Web (Web), located on the Internet; however, the network 4 can be any combination of wireless, mobile, radio, telephone, paging, automated teller machines, or other support technologies necessary to connect the user with the fund system 2. The fund system 2 advantageously is not limited to these types of networks 4 but is able to accommodate new networks as well as new brands, models, and standards, variations, or wholly new technologies or techniques for connecting a user with the fund system 2.

The operation of the mutual fund is dependent upon its participants voting for the acquisition or sale of a security. Once the fund system 2 determines that a security should be purchased or should be sold, the fund system 2 generates a market order. The advisor of the mutual fund manages the execution of the market order. The market order is preferably executed by contacting a financial provider 5, or a plurality of financial providers 5, in order to complete the purchase or sale in agreement with applicable law. In an alternative embodiment, the advisor may execute the market order without contacting a financial provider as long as the advisor may do so in agreement with applicable law. In yet another alternative embodiment, the market order may be automatically processed by the fund system 2 without using an external financial provider 5.

In the preferred embodiment, prospective participants can purchase shares of the mutual fund by contacting the mutual fund on the Internet, requesting an application and submitting the completed application with the appropriate funds to the advisor at the address provided on the Web site. In return for contributing monies to the mutual fund, the participant receives shares from the advisor. The share price at the inception of the mutual fund is determined by the advisor. In an alternative embodiment, the participants' ownership interests may be designated as such other than shares.

The participants actively engage the investment management process through the Internet by nominating and voting for securities to be purchased or sold by the advisor. The advisor operates alone or with the help of a management staff. The adviser executes the participants' instructions, after ensuring that each transaction can be practicably carried out. For example, the advisor will not buy a security prohibited by the mutual fund's cash position or by applicable regulatory constraints. Specifically, the security voted for purchase should further the mutual fund's objective of long-term growth, which is typically accomplished by investing in New York Security Exchange, American Security Exchange or NASDAQ National Market-listed companies that are introducing or benefiting from major new technologies or business models, or that otherwise have the potential for very high growth rates.

II. Methods

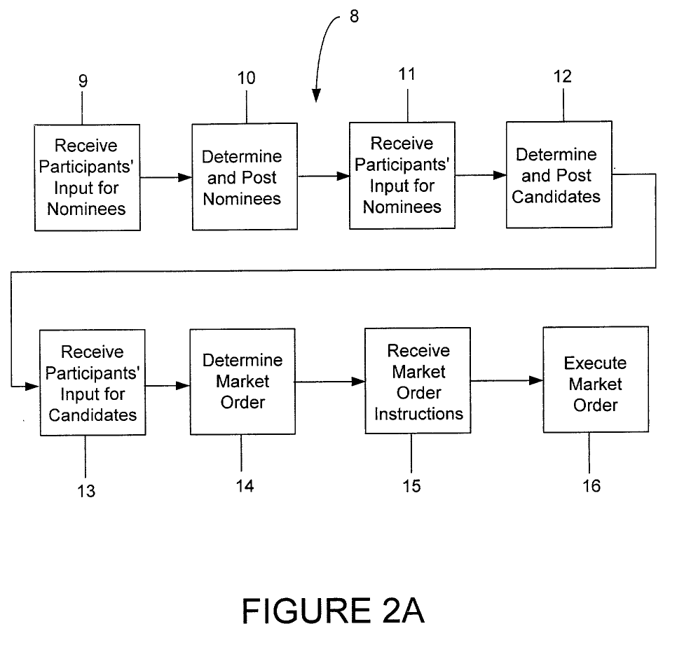

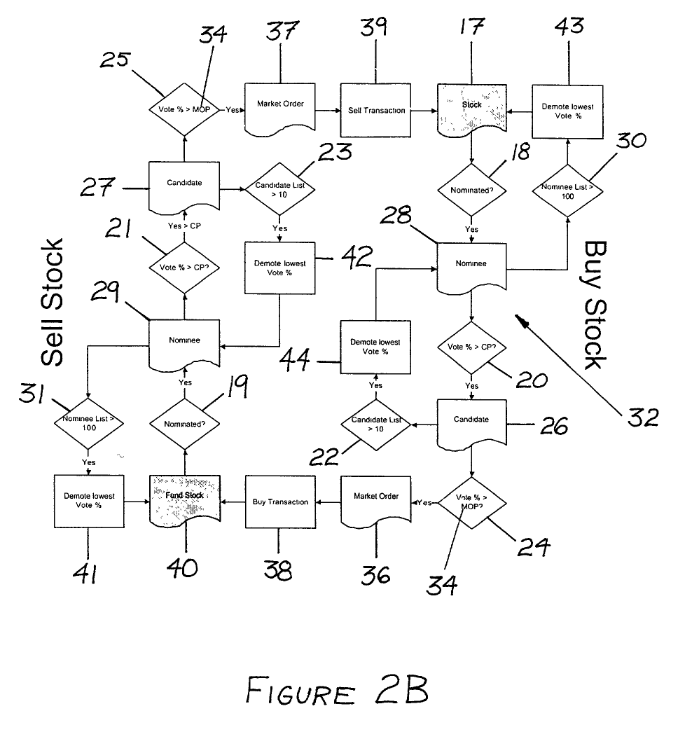

According to the preferred embodiment, as shown in FIG. 2A, the mutual fund's holdings are determined by the participants through the voting cycle 8, which is controlled by the fund system 2. The voting cycle 8 begins at 9 with the fund system 2 receiving a participant's nomination for the acquisition or sale of a security. Preferably, the security nominated is a stock. However, in an alternative embodiment, participants may vote for the mutual fund to purchase public or private bonds, futures, options, commodities, real estate, real estate investment trusts, money market funds, certificates of deposit, any combination thereof, or any other investment opportunity, as long as a purchase of the security is not prohibited by law or contrary to the objectives of the mutual fund.

Once the fund system 2 has received a nomination, the fund system 2 at 10 determines whether the nominated security complies with the mutual fund's investment criteria and posts all nominated securities that are in compliance within the fund system 2. All posted nominated securities, nominees, are voted on by the participants by submitting votes to the fund system 2. The fund system 2 receives votes for the nominees at 11. The fund system 2 thereafter determines whether the security acquired votes greater than a predetermined threshold, thus making the security eligible to become a candidate security. Additionally, the fund system 2 posts those securities which have become candidates for sale or purchase at 12. The fund system 2 receives the participants' votes for the candidates at 13. However, only those participants who did not vote for the security as a nominated security are eligible to vote for the security as a candidate.

Thereafter, the fund system 2 determines whether the security acquired votes greater than a predetermined threshold, the MOP, thus enabling the security to become the subject of a market order at 14. In a preferred embodiment, the MOP varies daily as the participants vote each day on what the MOP should be for the next day in their opinion. However, in alternative embodiments the MOP is a fixed number which remains constant. Further, the MOP may be set by the participants and remain fixed thereafter. Still yet, the MOP may be set at a regular basis; such as daily, weekly, or monthly. If an investment has become the subject of a market order, the fund system 2 receives the market order instructions at 15 and manages the execution of the market order at 16, as set forth previously.

As shown in the detailed block diagram of FIG. 2B, all participants and the advisor may nominate securities for purchase or sale. In order to vote or nominate, the participant first logs onto the secure Web server using a user ID and password. Alternatively, the participant may nominate a security by responding to an electronic message, a telephone call or other such request for a vote or nomination. Additionally securities may be purchased, even if the identical securities are already owned by the mutual fund, as long as the purchase would not cause the fund holdings of that security to become greater than five percent of the total holdings. Alternatively, the five percent threshold may be increased or decreased. There are no limits on how many securities may be nominated, provided that the securities nominated for purchase adhere to the objectives, restrictions, and investment strategies determined by the advisor and found in the prospectus and do not result in the fund accumulating more than 25% of its holdings in one industry sector. In an alternative embodiment, the 25% threshold may be adjusted at the advisor's discretion, set by the participants, or set in another fashion.

During the nomination process for the purchase of a security, a participant includes the security's ticker symbol, the Internet address (URL) for the company Web site, a brief rationale for nominating the security for purchase, and an explanation as to how the security qualifies for purchase under the restrictions set forth in the prospectus. The fund system 2 does not accept nominations for the purchase of security for which the fund system 2 already owns five percent of the total holdings of the mutual fund. Further, the fund system 2 does not accept nominations to sell a security that is not owned by the mutual fund. Once nominated, as determined at 18, the fund system 2 posts the security to the nominee list as a nominee at 28 provided that, if nominated for purchase, the fund system 2 does not already have five percent or more of its total assets invested in that security. Additionally, the fund system 2 posts the nominated security to the nominee list at 30. Preferably, the nominee list may contain an unlimited number of nominees. Alternatively, the nominee list may be limited to a designated number, which may further be increased or decreased.

When a security becomes a nominee at 28, it then appears, along with other nominated securities, on a nominee list 28. Each nominee list 28 consists of securities nominated for consideration by the participants. The advisor has the authority to remove those securities from the nominee list 28 that have occupied the list the longest and have the lowest percent of shares voted in their favor. Alternatively, the threshold for removal of a security could be increased or decreased. The advisor reserves the right to remove securities at its sole discretion from the nominee list 28, or to refuse to list securities on the nominee list 28, which do not meet the mutual fund's objectives or strategies as described in the prospectus. The mutual fund does not allow short sales of securities.

Voting and nomination are performed as separate acts. Once a security is nominated 18 for purchase, it becomes a nominee 28, whether any votes have been cast in favor of the security or not. The act of nomination does not automatically obligate a participant to vote his shares in favor of that nominee. Rather, a vote is cast separately from a nomination. Thus, a participant can nominate a security and can vote for the nominee 28 in two separate steps.

Once a security is on the nominee list 28, participants may vote for the nominee 28 to purchase it for the mutual fund 38. All securities which have been nominated for purchase are located on the buy nominee list 28. Participants can only vote once to buy 38 a security during a voting cycle 32, which begins with nominating the security and ends when the security is bought or removed from the nominee list 28. When participants vote their shares, the votes are recorded in favor of the nominee 28. The participant preferably should not vote only part of the participant's shares. Instead, a vote for a nominee 28 is a vote of all of the shares of the participant. Each participant's vote is weighted by the number of shares owned by the participant in order to determine the percentage voting for the security. The percent of shares voted in favor of the nominee 28 is updated regularly, preferably every 20 minutes, or in real time, and displayed to two decimal places on the Web site's nominee list 28.

Once votes representing five percent or more of the mutual fund's outstanding shares are cast for a nominee 28, it may become a candidate 26, and be placed on the candidate list 22. The five percent threshold is set by the advisor and may be accordingly adjusted up or down. Candidates 26 appear on a candidate list 22, which includes no more than ten securities. Once again, the Advisor may adjust this threshold as well. All securities located on the candidate list 22 have first been listed on the nominee list 28. If a security on the nominee list 28 receives a vote of at least five percent of the outstanding shares, it is eligible to be placed on the candidate list 22. If the candidate list 22 maintains fewer than ten securities, the nominee 28 receiving votes in excess of the five percent threshold and receiving the highest percent of participant votes is removed from the nominee list 28 and placed on the candidate list 22. On the other hand, if the candidate list 26 contains ten securities, the voted for nominee 28 can not be placed on the candidate list 22 until a vacancy occurs through the purchase or removal of a security 22. A security is removed if a nominee has received more votes than a security located on the candidate list 44. The mutual fund's Web site updates the candidate list continuously to display the ten securities regularly, preferably every 20 minutes, or in real time, with the highest percent of shares voted in their favor and which have met the minimum five percent requirement or other percent determined by the advisor.

When an investor is voting 20 to purchase 38 a security, the participant also enters the amount of security to purchase by entering the percent, up to five percent, of the mutual fund's total assets to be invested in the security. The participant's vote to purchase 24 and the percent to purchase is weighted with the number of shares owned by the participant. If the security to be purchased consist of shares, the mutual fund purchases the average number of shares requested, rounded to the nearest 100. However, the mutual fund will not purchase one security in excess of five percent of the mutual fund's total assets, nor will it purchase a security that will cause the mutual fund to exceed five percent of the total holdings for that security.

A candidate 26 is purchased 38 once it has received participant votes in excess of the MOP 34. After a candidate 26 has received votes in excess of the MOP 34, the candidate 26 automatically becomes the subject of a market order 36 that is sent to the advisor, who then buys 38 the indicated amount of the security 17 as soon as is practicable. The market order 36 is placed with a qualified brokerage firm only if there exist sufficient funds to conduct the trade and the trade, in the advisor's sole opinion, will not violate any applicable legal or regulatory constraints. Participants have no input into the actual price at which a trade is executed or the time of execution. In an alternative embodiment, the advisor executes the market order, in accordance with applicable law.

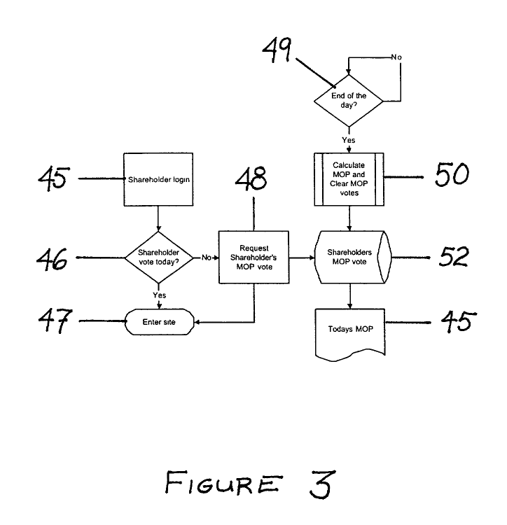

The MOP 34 is preferably updated daily and changed by the participants, as shown in FIG. 3, to ensure that the mutual fund has the ability to quickly react to a favorable market and the ability to react more slowly to an unfavorable market. The first time a participant accesses the mutual fund's Web site on a particular day 45 the participant is required to enter 48 a value for the MOP 34, which is used to recalculate the MOP 34 for the next day 46. In an alternative embodiment, the MOP is adjusted at the advisor's discretion or as set forth above. A participant is not permitted to enter the site 47 until the participant has entered a value for the MOP 34. Alternatively, the participant is only requested to enter a value for the MOP. The MOP 34 is recalculated on a daily basis by averaging the past five days of participant input. Participant votes for the MOP 34 are not weighted by number of shares owned; rather, a one-person, one-vote rule applies.

Preferably, the MOP is calculated before 9:00 a.m. each business day, before the opening of the NYSE. After midnight of each day, 12:00 am eastern standard time 49, the MOP 34 to be used for the next day is calculated and the participants' votes for the MOP 34 are cleared from the vote registry 50. Thereafter, the fund system 2 is once again ready to accept the participants' MOP vote 52 and to publish the applicable MOP 34 in the fund system 2. The MOP 34 maintains a minimum level as set by the advisor in order to ensure that the decisions to buy and sell securities are not made by a small percent of the participants. The MOP 34 minimum is five percent but may be changed by the advisor at his discretion.

The MOP 34 is a part of the management process and varies daily, as participant and broad market sentiments change. For instance, during periods of nervousness, negativity or very high valuations, it is expected that participants will increase the MOP 34 by their voting, in order to make it more difficult for a security to be either bought or sold. This will have the effect of requiring a higher degree of unanimity on the part of participants before buying or selling a security during periods of overvaluation. During periods of corrections, it is expected that participants as a group will vote to decrease the MOP 34, in order to make it possible to more easily and quickly add desirable securities to the mutual fund. Thus, the MOP 34 voting process makes the mutual fund more flexible and able to quickly respond to various market and economic conditions.

In order to sell an investment held by the mutual fund, the participants complete a process that is substantially similar to the process set forth above for acquisition of an investment, as seen in FIG. 2B. Specifically, a security 40 is nominated by a participant. If the nomination complies with all applicable criteria 31 and 41, the nominated security becomes a nominee 29 and the participants are given the opportunity to vote on whether the holding should become a candidate 21.

The fund system 2 records the votes and if the nominee receives votes that total more than the applicable threshold and there are less than ten candidates on the candidate list 23, the nominee becomes a candidate 27. Alternatively, this threshold could be increased or decreased. If more than ten candidates are listed, the nominee becomes a candidate if the nominee receives more votes for sale than any one of the ten currently listed candidate holdings 42. Essentially, the nominee replaces the currently listed candidate having a lower vote count and returns that candidate to the nominee list 29.

Once a security is listed as a candidate for sale, participants who have not voted on the holding as a nominee may vote for the security at their discretion 25. When a participant is voting to sell a holding 25, the participant enters the percent of the security that the advisor should sell in twenty-five percent increments, 25%, 50%, 75% or all of the security. Alternatively, the increments of the security to be sold could be increased, decreased, or completely removed. Once again, the participant's vote to sell 25, including the amount to sell, is weighted with the number of shares owned by the participant. The amount of the security to be sold is determined by averaging the votes. If the security is a stock, the advisor sells the amount of shares rounded down to the nearest 100. If the weighted average is greater than 75% the advisor sells all of that security held by the mutual fund. Alternatively, the 75% threshold could be increased, decreased, or completely removed. If the vote is greater than the MOP, the security becomes the subject of a market order 37. As described in the method for purchase above, the advisor executes or manages execution of the market order 39.

While the voting cycle for purchasing an security is identical to the voting cycle for selling a security, not all of the applicable thresholds are necessary equal. For example, the MOP for the selling voting cycle may differ from the MOP of the purchasing voting cycle. However, it is also possible that both MOP could have the same value. Similarly, the threshold of votes necessary for a security nominated for purchase to receive before it can become a candidate may differ, either higher or lower, from the threshold applicable to the sale of a security. In the same light, the threshold for the sale of a security may be adjusted higher or lower as well.

III. Participants' Responsibilities

In order to ensure the viability and success of the mutual fund, each participant should actively participate in the management of the mutual fund. Thus, participants are encouraged to complete their responsibilities, which may include:

1) monitoring the mutual fund's holdings and cash position, as provided by the advisor on the Web on a regular basis, preferably every 20 minutes, yet may be in real-time, to determine how much cash is available for mutual fund purchases;

2) performing research to find securities that are appropriate investments for the mutual fund;

3) nominating securities to be purchased or sold for the mutual fund and provide the company's Internet address (URL) and a brief rationale for the nomination;

4) voting on whether candidates should be purchased or sold;

5) classifying securities nominated for purchase in terms of industry sectors; and

6) establishing the MOP, the percent of outstanding shares required to purchase or sell securities, by voting each day the first time that they log onto the Web site, but not more than once per day.

IV. Advisor's Responsibilities

In the preferred embodiment of the invention, as much of the investment management process as possible is placed in the hands of the participants. The advisor can have varying degrees of participation. For example, the advisor may only supervise the process to ensure that activities of the mutual fund comply with all applicable regulations. The advisor may have additional responsibilities that are fulfilled solely at the advisor's discretion, at the request of the participants, or at all times. The advisor may determine that it should act or supersede the normal management process, in which case the participants have no input. The advisor's responsibilities may include one or more of the following:

a) buying or selling a security after it has achieved the MOP, and becomes a market order;

b) setting the percent at which a nominee becomes a candidate (the advisor may change this percent as deemed necessary to maintain a flow of security from nominee to candidate status, depending on experience, and the number of participants that actually vote on a regular basis);

c) providing participants access to brokerage research;

d) ensuring that the cash held in the mutual fund is properly invested in interest-bearing securities, either through a money market fund, or by direct purchase,

e) ensuring, to the extent practicable, that the mutual fund's investable cash is adequate for potential redemptions during normal market conditions, without having to be forced to sell securities to meet redemptions;

f) determining, during market emergencies (such as requests for redemptions in excess of cash available to meet those redemptions), which mutual fund securities to sell, and to execute the sales without going through the normal voting process;

g) calculating the percent of shares voted in favor of each nominee and candidate on a continuous basis, or as soon as possible (participants may vote on non-business days and hours, and their votes will be continuously updated);

h) determining the exact number of shares to buy (when participant votes in favor of a security have converted a candidate into a market order the advisor will round the number of shares downward to the nearest 100 shares);

i) determining the final number of shares of the mutual fund's holdings in a security to be sold, as calculated by an algorithm that will weight each 25% increment by the number of votes cast for that increment and if the weighted percent is in excess of 75%, then 100% of the mutual fund's holdings will be sold;

j) selling very small amounts of security left in the mutual fund by participants with such amounts defined as anything below 0.10% of total mutual fund assets (this percent may be changed at the discretion of the advisor);

k) purchasing securities in the order of the MOP, highest MOP first, until available cash is exhausted;

l) selecting which brokers to use, and which brokers to direct trades to, in return for research and other services to the mutual fund participants;

m) negotiating with brokerage firms the transaction fees to be charged to the mutual fund;

n) determining how and when to execute an order to purchase or sell security;

o) redeeming shares of any participant who does not participate in the voting process during a 182 day period, who behaves in a manner on message boards or in chat rooms that is unnecessarily rude or abusive, who posts research or other information in violation of the policies of the research or other firm, or who violates the rules of the SEC regarding securities trading on insider information, front running, etc.; and

p) defining industry sectors and determining in which sector a security belongs (the advisor may change the designation of a security if, in its discretion, the advisor believes that the designation has been made incorrectly.

Additionally, the advisor preferably should ensure that the activities engaged in by the mutual fund are in compliance with governing law by:

1) ensuring that the mutual fund does not violate the rules or regulations governing the mutual fund's operations;

2) ensuring that nominees adhere to the mutual fund's stated investment objective and strategies (this can be achieved by creating a list of securities that will be automatically rejected by the Web site whenever they are nominated);

3) interpreting, whenever necessary, the mutual fund's investment objectives and strategies as stated in the prospectus;

4) alerting participants when a sector is in excess of the maximum allowed 25% of mutual fund assets, and call for sale nominees from that sector (if none are proposed, or none reach the MOP within 7 days, the advisor may decide what to sell to bring the mutual fund into compliance); and

5) voting proxy statements in the best interests of the participants.

V. Preferrable Screen Displays

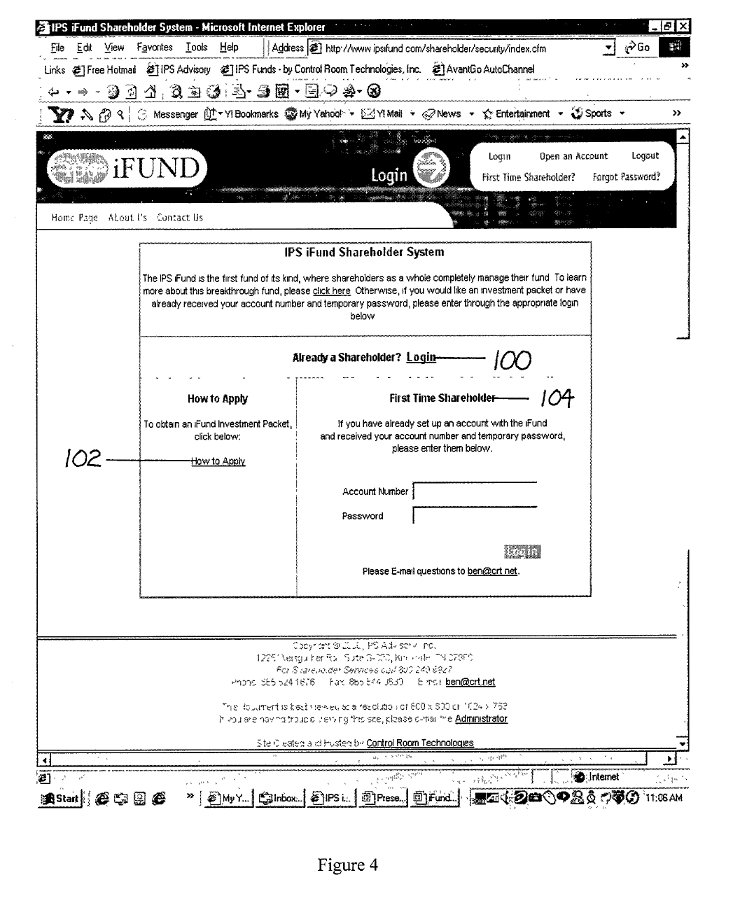

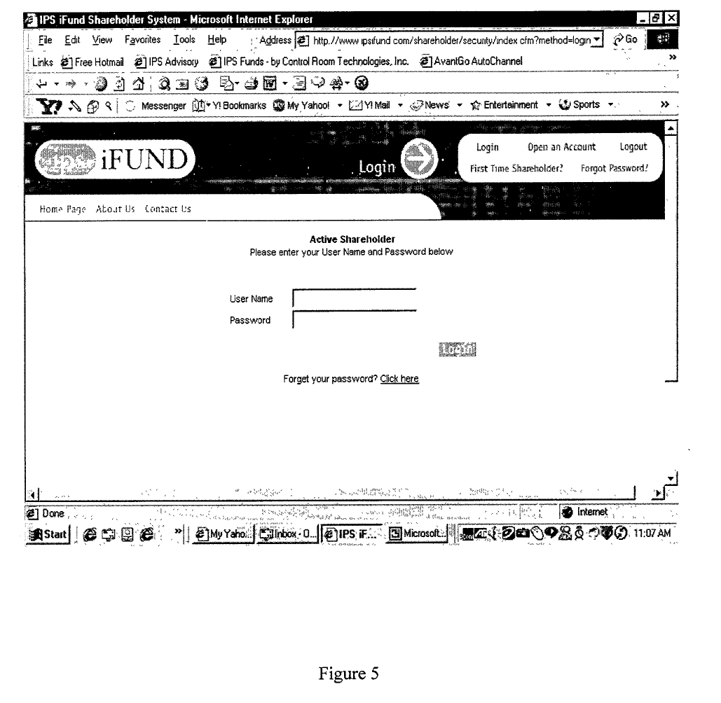

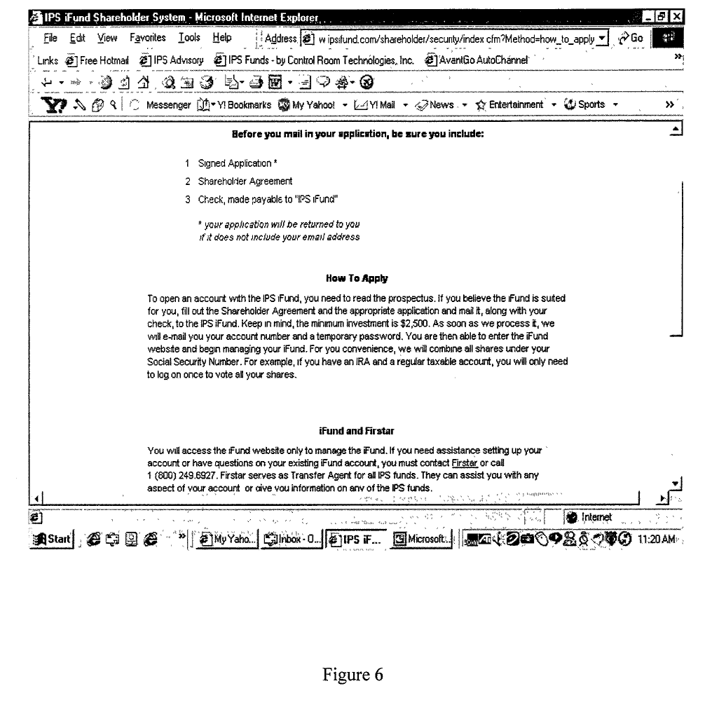

In the preferred embodiment, the first screen that a participant or prospective participant views at the Web address, preferably ipsifund.com, is shown in FIG. 4. If the Web user is already a participant, the participant should click on the Login icon 100 and proceed to the next screen, as shown in FIG. 5. On the other hand, if the Web user is a prospective participant, the user should click on the How to Apply icon 102, which will allow the participant to view the necessary contact information, as shown in FIG. 6. Specifically, a prospective participant contacts IPS to receive a copy of the prospectus, enabling the user to read the prospectus prior to investing in the mutual fund. An account is opened once the user has submitted the appropriate application together with the minimum investment amount and shareholder agreement. After IPS is able to establish an account, the new account holder is given an account number and a temporary password, preferably by electronic mail, which enables the new account holder to access the system through the First Time Shareholder icon 104, as shown in FIG. 4.

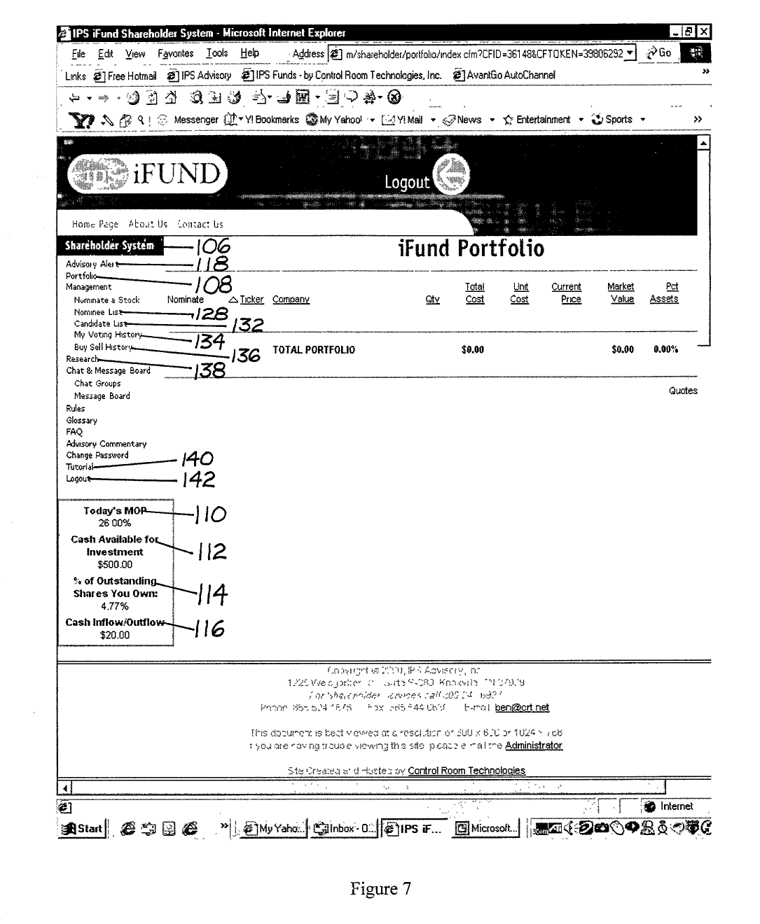

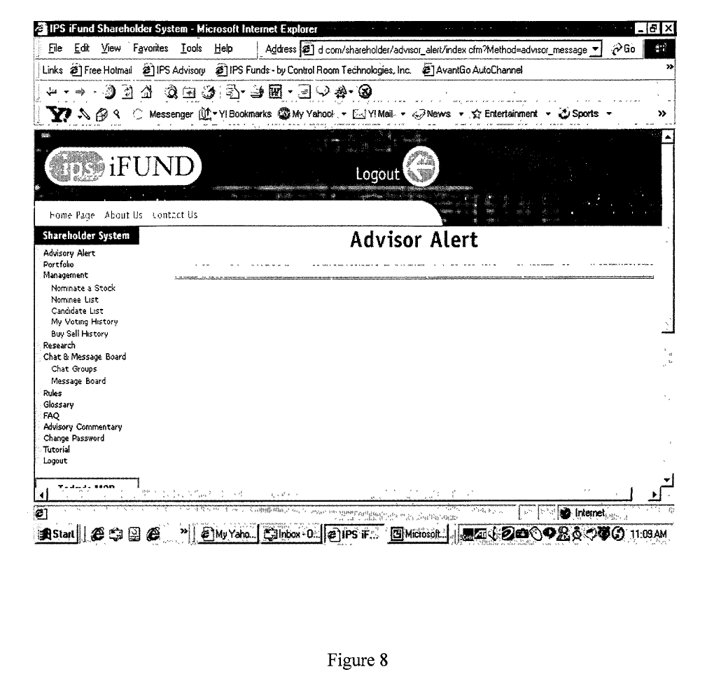

Once the participant has gained access to the system, the participant is able to view a number of options. Each of the following options is available to the participant by clicking the icon containing the corresponding title on the menu bar 106. The participant may view his holdings with the mutual fund by clicking the Portfolio icon 108, as shown in FIG. 7. Included within this screen is the MOP for the day 110, the cash available for investment 112, the percent of outstanding shares owned by the participant 114, and the cash inflow/outflow 116. The advisor is able to notify the participants under the Advisor Alert icon 118, as shown in FIG. 8.

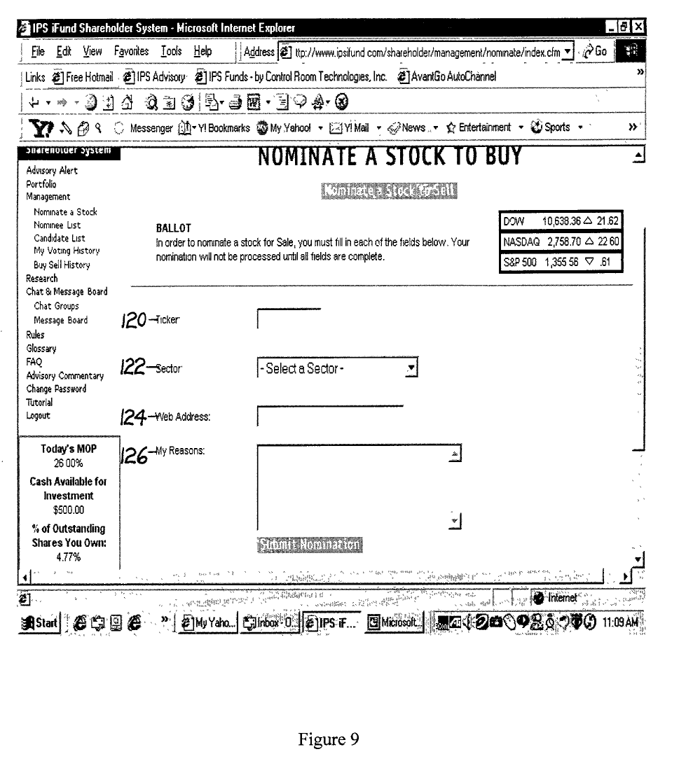

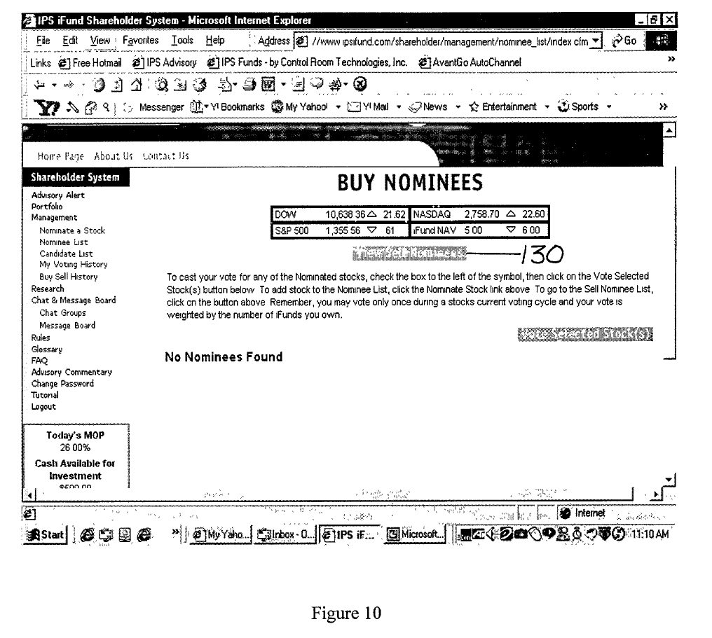

After the participant has sufficiently researched a security and feels confident that the security will increase in value, thereby benefiting the mutual fund, the participant may nominate that security, as shown in FIG. 9. In order to nominate a security, the participant provides the ticker symbol 120, the sector of the economy in which the company does business 122, the company's Web address 124, and the participant's reasons for nominating the security 126. Once the security has been nominated, it is placed either on the buy nominee list or on the sell nominee list. The participant can view the nominees by clicking on the Nominee List icon 128, which allows the participant to view a nominee list, as shown in FIG. 10. From the screen displayed in FIG. 10, a participant may vote to buy a nominated security by clicking a box to the left of the security's ticker symbol, not shown. The participant can view the sell nominee list by clicking the View Sell Nominees icon 130, as shown in FIG. 10. This will allow the participant to view a page that is very similar to the format of the page shown in FIG. 10, except that the nominees listed will correspond to the securities that have been nominated to be sold.

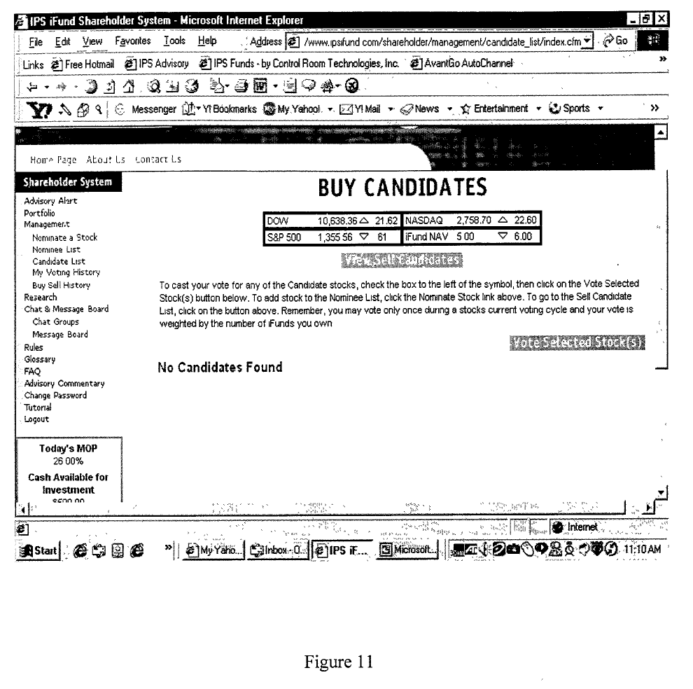

The participant can also vote on candidate securities, provided that the participant has not previously voted on the security as a nominee. The candidate list can be viewed by clicking on the Candidate List icon 132 on the menu bar, as shown in FIG. 11. A participant may vote for a candidate by checking a box located adjacent to the security's ticker symbol, not shown.

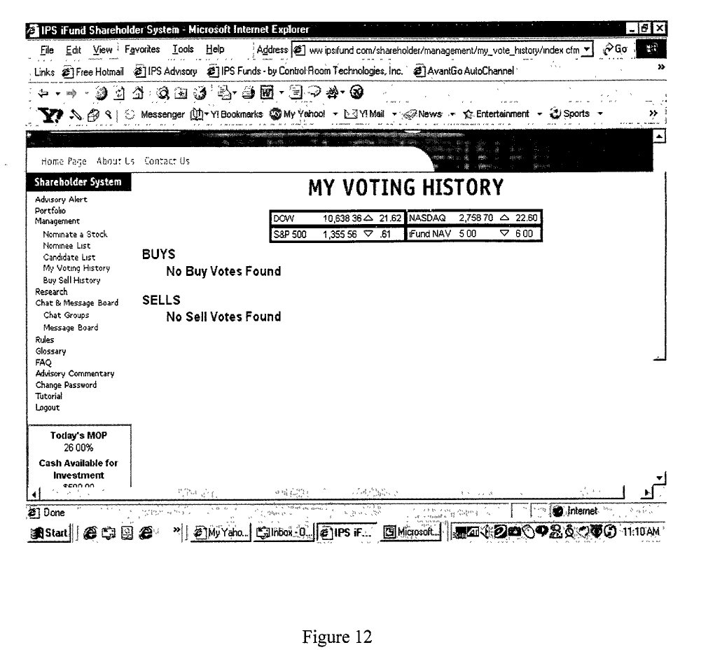

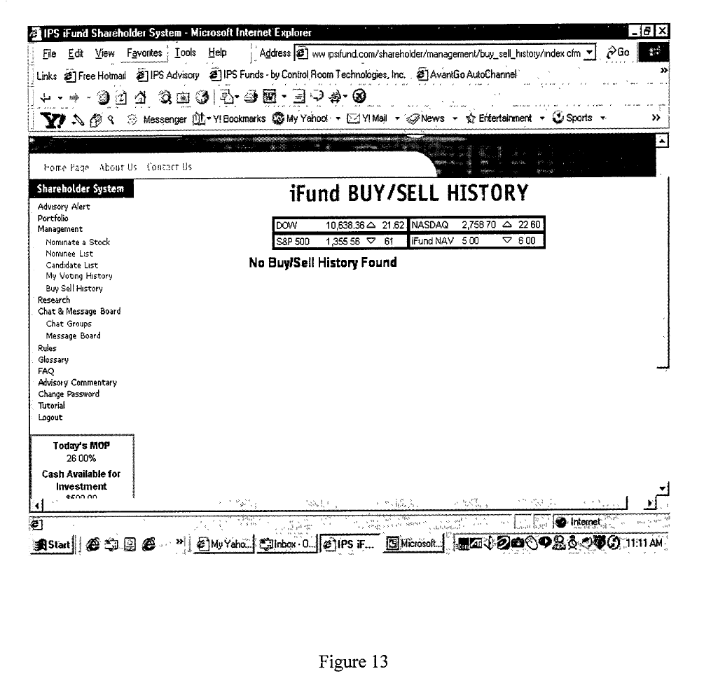

The on-line environment allows the system to update the records regularly, preferably every 20 minutes, or in real time, thereby providing the participant with quick and easy access to accurate account information. The participant can view his voting history by clicking on the My Voting History icon 134, as shown in FIG. 12. The participant may also view the buying and selling activity of the mutual fund by clicking on the Buy Sell History icon 136 which allows the participant to view a page as shown in FIG. 13.

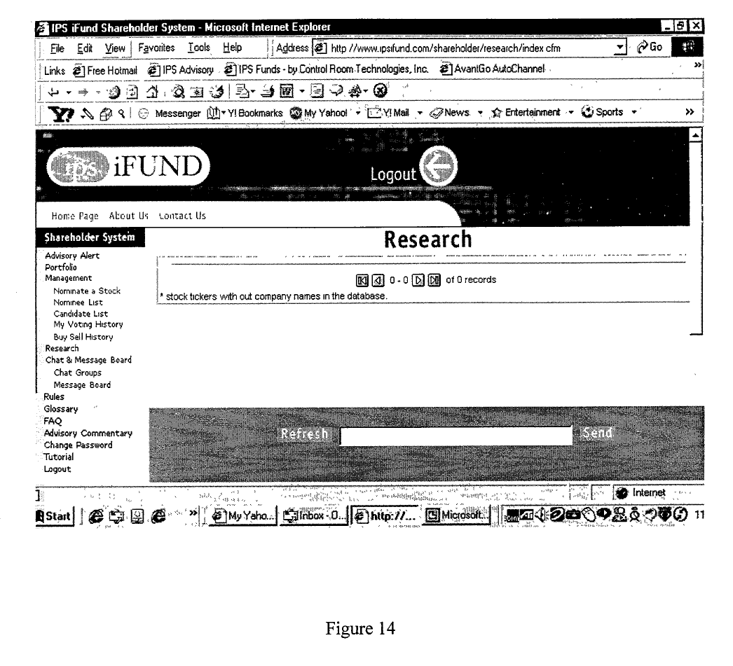

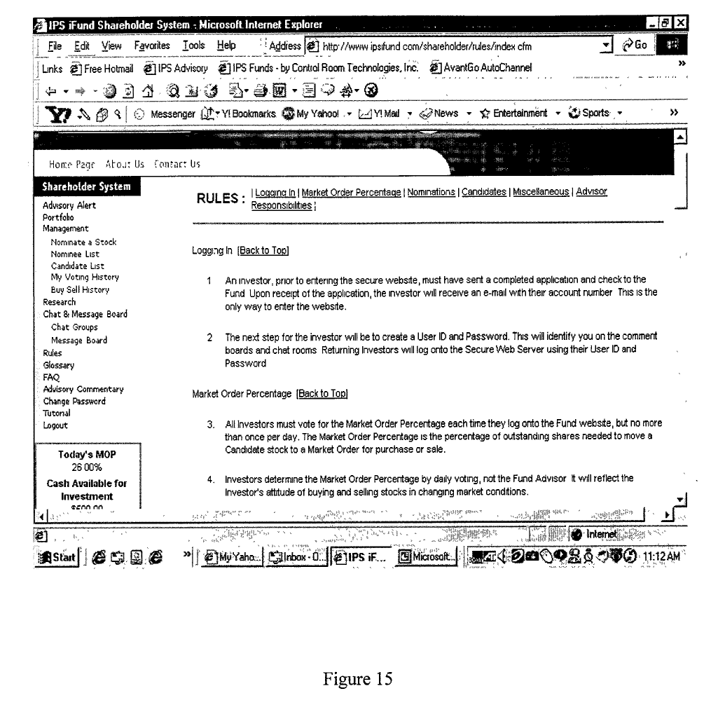

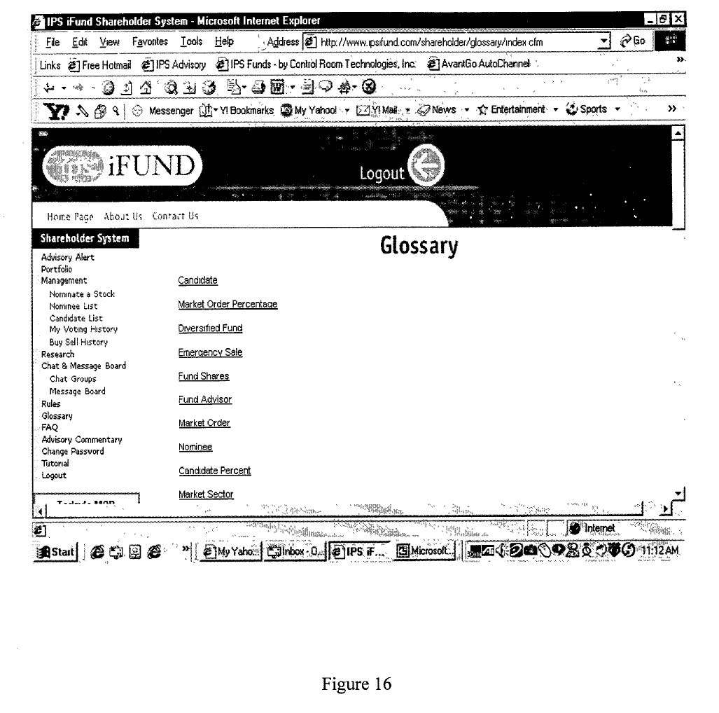

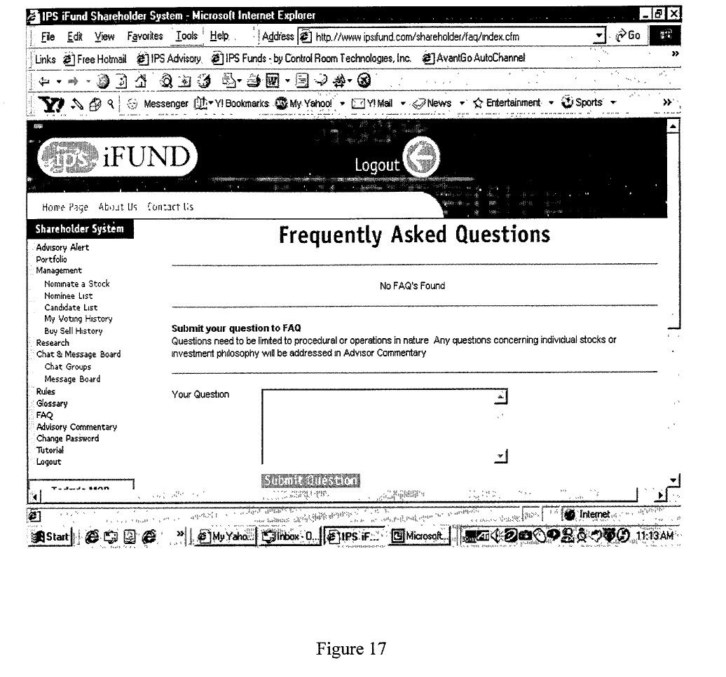

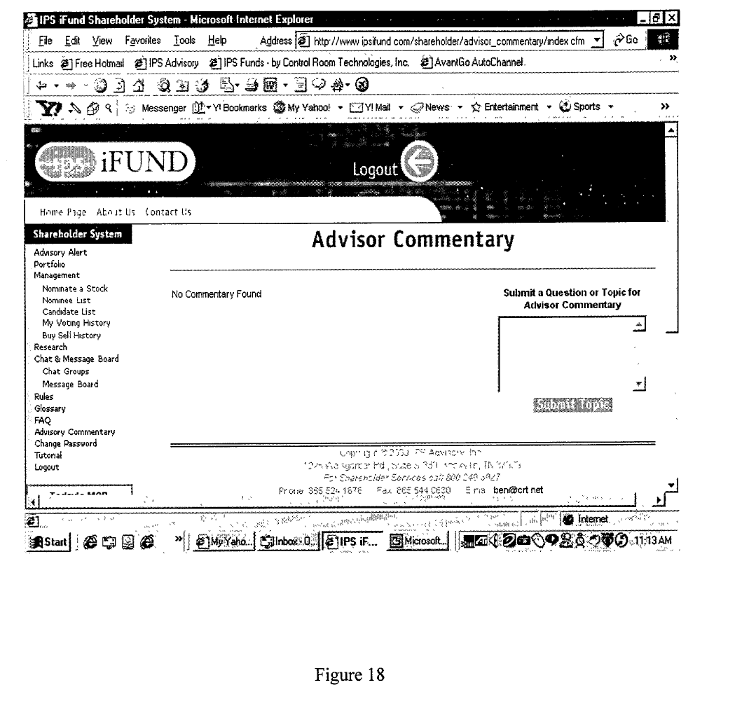

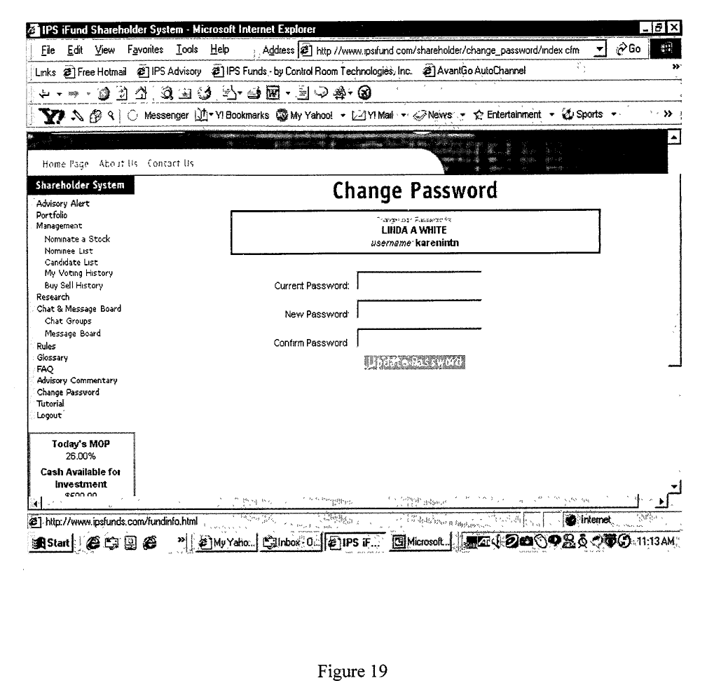

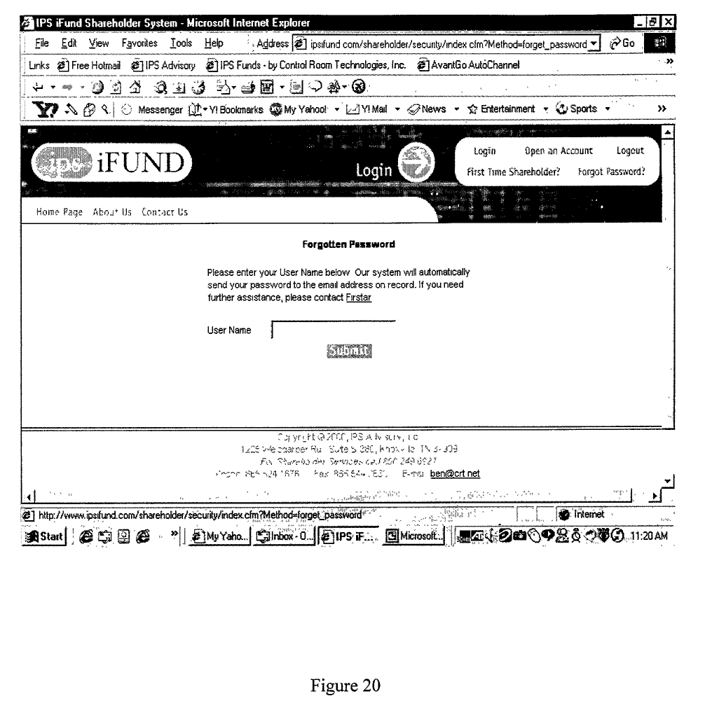

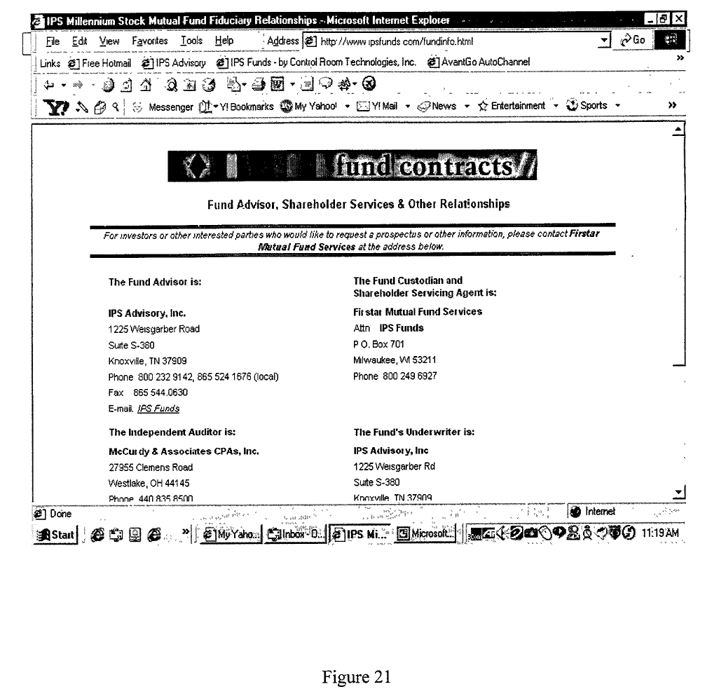

The strength and viability of the mutual fund relies upon the knowledge of each participant. In an effort to increase the knowledge of each investor, the participant may click on the Research icon 138, which will take the participant to a page as shown in FIG. 14. The Web site also includes various pages which provide the participant with avenues to seek answers to frequently asked questions without having to call a representative of the fund system 2, including: a rules page, FIG. 15; a glossary, FIG. 16; a page providing answers to frequently asked questions (FAQ), FIG. 17; a page providing commentary from the advisor on various investing issues, FIG. 18; a page where the participant can change his password, FIG. 19; a page where the participant can request that the advisor mail a password in the event that the password is forgotten, FIG. 20; and a page containing contact information for the mutual fund, FIG. 21.

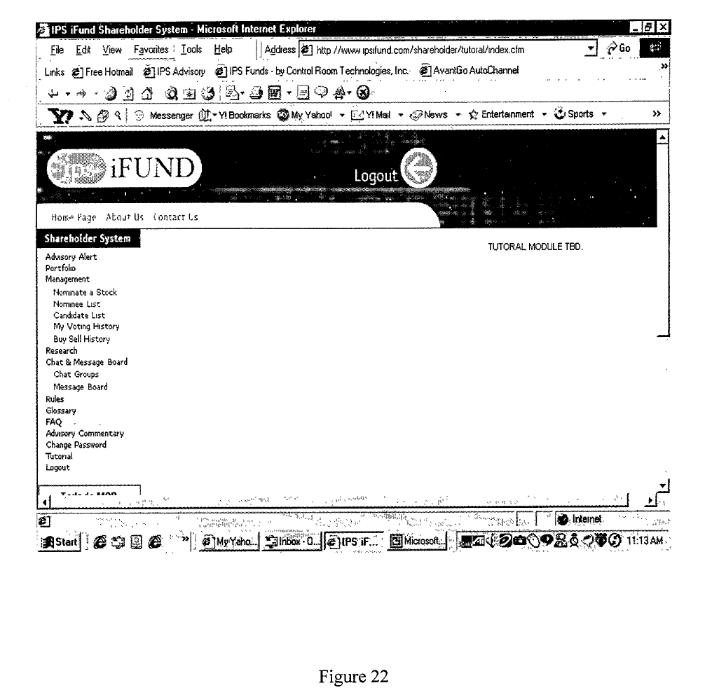

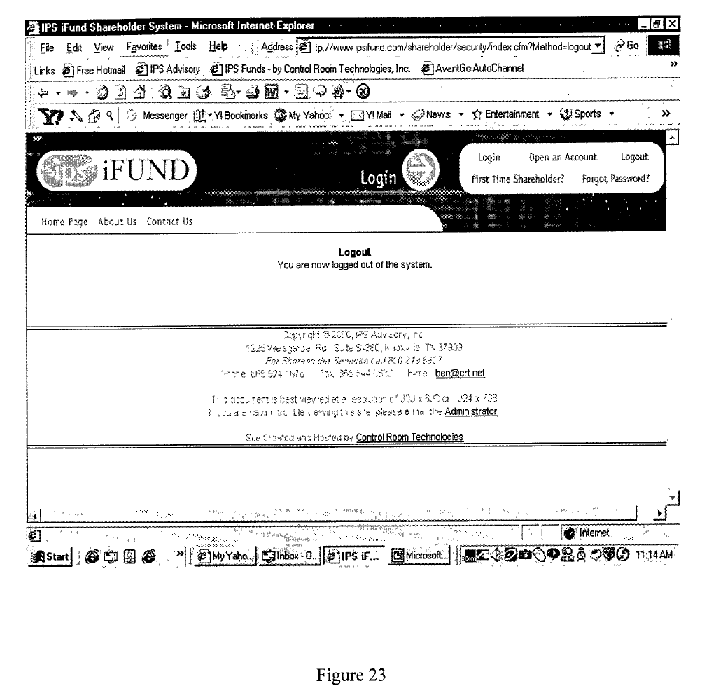

The interactive mutual fund concept requires that participants devote time to fully understanding the rules and criteria before proceeding. In order to properly orient a new participant to the Web site, the Web site includes a tutorial that is available to the participant by clicking the Tutorial icon 140, as shown in FIG. 22. Once the participant has finished using the Web site, the participant may terminate contact with the Web site by clicking the Logout icon 142, as shown in FIG. 23.

VI. System Support

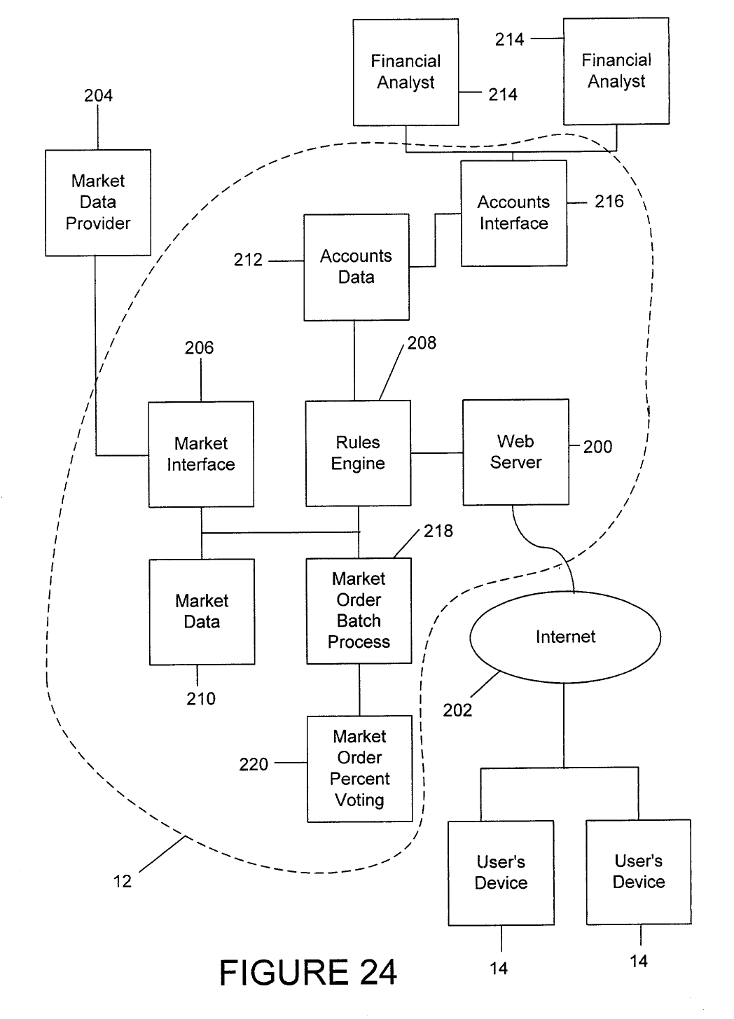

Preferably, a Web server 200 stores the fund system 2, as shown in FIG. 24. Individual participants and prospective participants (users) 14 can access the fund system 2 through the Internet 202; however, as set forth above, the user 14, or a plurality of users, can connect with the fund system 2 through other networks.

A market data provider 204 provides the fund system 2 with financial information on a regular basis, such as every fifteen minutes, Monday through Friday. Preferably, the market data provider is the North American Quotations Security Feed (NAQ). Additionally, the financial information compiled by the NAQ includes, but is not limited to, market indexes, fund data, the current value of securities and other relevant investment information. The market data provider 204 sends financial information to the fund system 2 through the market interface 206. The market interface 206 runs MS SQL Data Transformation Service to load both the index and fund data provided by NAQ into the market database 210. In an alternative embodiment, market data 210 is provided by another source or a plurality of sources.

When a participant is granted access to the fund system 2, the participant can view relevant account data 212 on the Internet 202. Each participant's account data is stored by a financial analyst 214 or a plurality of financial analysts 214, such as Firstar. The account data 212 is calculated with information included within an account batch feed from the financial analyst 214. An account interface uses the MS SQL Data Transformation Service and processes the account batch feed to arrive at participants' accounts to recalculate shares and votes, and to produce a log or multiple logs, which are stored in accounts database 212. Preferably, the batch feed is available for calculation on a daily basis at 5:00 a.m. The accounts interface 216 transfers the results of the processing to the account database 212.

In order to institute the voting criteria, the MOP is calculated on a daily basis. A market order batch process 218 calculates the MOP using the MS SQL Data Transformation Service together with the average daily MOP voting 220. Additionally, the market order batch process 218 updates the MOP history to include the recently replaced MOP.

While various embodiments of this invention have been set forth above, these descriptions of the preferred embodiment are given for purposes of illustration and explanation and are not intended to be exhaustive or to limit the invention to the precise forms disclosed. Variations, changes, modifications, and departures from the systems and methods disclosed above may be adopted without departure from the spirit and scope of this invention. The embodiments were chosen and described in order to explain the principles of the invention and their practical application so as to enable others skilled in the art to utilize the invention and various embodiments and with various modifications as are suited to the particular use contemplated.

We claim:

1. A method of managing a financial investment fund having a plurality of securities, the managing being conducted by a plurality of participants, comprising:
receiving votes from the participants of the financial investment fund regarding executing a market order for a security, wherein each participant is a partial-owner of the financial investment fund;
totaling the votes to produce a total vote count;
comparing the total vote count with a market order threshold;
executing the market order, if the total vote count is greater than the market order threshold; and
wherein executing the market order for the security involves altering the composition of the financial investment fund with respect to the security.

2. The method of claim 1, wherein the security comprises a candidate security and receiving votes comprises receiving the votes for the candidate security, the method further including receiving nominations for security to become the candidate security.

3. The method of claim 2, further including:
totaling the nominations for a nominated security to produce a total nominated vote count;
comparing the total nominated vote count with a nomination threshold; and
converting the nominated security into the candidate security if the total nominated vote count exceeds the nomination threshold.

4. The method of claim 1, wherein executing the market order comprises purchasing the security.

5. The method of claim 1, wherein executing the market order comprises selling the security.

6. The method of claim 1, wherein the market order threshold comprises a market order percent, the method further comprising receiving the market order percent from the participants.

7. The method of claim 6, wherein receiving the market order percent comprises setting the market order percent based on input received from the participants on a regular basis.

8. The method of claim 6, wherein receiving the market order percent comprises:
receiving market order votes from the participants; and
averaging the market order votes to arrive at the market order percent.

9. The method of claim 8, wherein receiving market order votes and averaging the market order votes occurs on a regular basis.

10. The method of claim 6, wherein receiving the market order percent comprises setting a minimum market order percent.

11. The method of claim 1, further comprising receiving additional funds from the participants and investing the additional funds by receiving votes, totaling the votes, comparing the total vote count, and executing the market order.

12. The method of claim 1, wherein receiving votes comprises receiving votes for a plurality of securities.

13. The method of claim 1, wherein executing the market order comprises instructing a financial provider to execute the market order for the security.

14. The method of claim 1, further comprising reviewing the market order to ensure the market order complies with rules regarding management of the financial investment fund.

15. The method of claim 14, wherein reviewing comprises having an advisor oversee management of the financial investment fund.

16. A method of managing a financial investment fund having a plurality of securities, the managing being conducted by a plurality of participants, comprising:
receiving nominations from the participants of the financial investment fund recommending a market order for a security, wherein each participant is a partial-owner of the financial investment fund;
receiving nomination votes from the participants regarding the market order for the security;
totaling the nomination votes to produce a total nominated vote count;
comparing the total nominated vote count with a nomination threshold;
converting the security into a candidate security if the total nominated vote count exceeds the nomination threshold;
receiving candidate votes from the participants for executing the market order for the candidate security;
totaling the candidate votes to produce a total candidate vote count;
comparing the total candidate vote count with a market order threshold; and
executing the market order if the total candidate vote count is greater than the market order threshold;
wherein executing the market order involves altering the composition of the financial investment fund with respect to the candidate security.

17. The method of claim 16, wherein executing the market order comprises purchasing the candidate security.

18. The method of claim 16, wherein executing the market order comprises selling the security.

19. The method of claim 16, wherein the market order threshold comprises a market order percent, the method further comprising receiving the market order percent from the participants.

20. The method of claim 19, wherein receiving the market order percent comprises setting the market order percent based on input received from the participants.

21. The method of claim 19, wherein receiving the market order percent comprises:
receiving market order votes from the participants; and
averaging the market order votes to arrive at the market order percent.

22. The method of claim 19, wherein receiving market order votes and averaging the market order votes occurs on a regular basis.

23. The method of claim 19, further including requiring each participant to vote for the market order percent before receiving the nomination votes or candidates votes from each participant.

24. The method of claim 16, further comprising weighting at least one of the nomination votes or candidate votes based on participant.

25. The method of claim 24, wherein weighting comprises weighting based on each participant's ownership interest in the financial investment fund.

26. The method of claim 16, further including determining whether a nominated security should replace a candidate security on the candidate list by comparing the total nominated vote count of the nominated security with a second total nominated vote count received by each security on the candidate list, and replacing the candidate security with the nominated security if the total nominated vote count of the security on the nominated list exceeds the nominated vote count previously received by that candidate security.

27. The method of claim 16, wherein executing the market order includes:
determining whether the security meets criteria on managing the fund;
determining whether sufficient cash exists to execute the market order; and
if multiple market orders are received for multiple securities, determining an order to execute the market orders based on the candidate votes.

28. The method of claim 16, wherein receiving nominations includes requesting that the participant provide information relevant to the nominated security.
